(19) United States
(12) Patent Application Publication
(10) Pub. No.: US 2023/0309553 A1
(43) Pub. Date: Oct. 5, 2023

(54) Compositions and Methods for Protecting Plant Roots and Enhancing Plant Growth

(71) Applicant: Midwest BioAg Holdings, LLC, Blue Mounds, WI (US)

(72) Inventor: Christopher D. Kniffen, Yankton, SD (US)

(21) Appl. No.: 18/193,846

(22) Filed: Mar. 31, 2023

Related U.S. Application Data
(60) Provisional application No. 63/326,630, filed on Apr. 1, 2022.

(51) Int. Cl. A01N 25/02; A01N 25/22; A01N 59/06; A01N 63/10; A01N 43/16; C05G 1/00; C05D 9/00; C05F 11/00; A01P 21/00

(52) U.S. Cl. CPC A01N 25/02; A01N 25/22; A01N 59/06; A01N 63/10; A01N 43/16; C05G 1/00; C05D 9/00; C05F 11/00; A01P 21/00

(57) ABSTRACT

Compositions and methods related to plant root protection, biological stimulation, and plant biomass enhancement are described. The compositions may comprise a dry blend of a low methoxyl (LM)-pectin powder; calcium and a sugar blend and are characterized by a viscosity, surface tension and saccharide composition comparable to plant mucilage and/or extracellular polymeric substances (EPS).

### RELATED APPLICATIONS

This claims the benefit of U.S. Provisional Application No. 63/326,630, filed Apr. 1, 2022, which application is incorporated herein by reference in its entirety.

### TECHNICAL FIELD

The subject matter of this disclosure relates to the field of plant root protection, biological stimulation, and plant biomass enhancement.

### BACKGROUND

Sedimentation of liquid slurries is a common problem when using liquid organic fertilizers. To date, the standard methodology for ameliorating these considerations is the employment of tank agitators which severely constrains the adoption of these organic fertilizer products, practically for those small and underserved communities without the capital for equipment investments. Leaching in the soil is also another primary concern with these products as the residency time in the rhizosphere is critical for efficacy.

In an effort to control the sedimentation of liquid slurries it was discovered that increasing the viscosity of the slurry could effectively decrease sedimentation fallout.

Common in the food industry, increasing the viscosity of a product provides even distribution of flavor and other components thus preventing stratification and sedimentation.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some aspects, the invention describes compositions that are a blend of a polysaccharide comprising a backbone of repeating D-galacturonic acid monomer units, a sugar and optionally calcium, where the compositions are characterized by gelling of the polysaccharide upon solubilization of the blend in water. In some aspects any of these compositions are applicable as a synthetic root exudate. In some aspects these compositions are formulated as a granular fertilizer.

In some aspects any of these compositions are applicable in methods of protecting plant roots, in a method of stimulating growth of plant roots and increasing plant biomass, in a method of delivering a product to a plant root system, in a method of enhancing residency time of beneficial agents in a plant rhizosphere, in a method of reducing heavy metal toxicity and salinity of plant roots, in a method of controlling the sedimentation rate of a liquid slurry suspension for use as a root stimulant, in a method of coating a seed.

Other methods, features and/or advantages is, or will become, apparent upon examination of the following figures and detailed description. It is intended that all such additional methods, features, and advantages be included within this description and are protected by the accompanying claims.

### DETAILED DESCRIPTION

We now describe in detail compositions and methods related to plant root protection, biological stimulation, and plant biomass enhancement. The compositions and methods also relate to uses as a water storage enhancement, soil stabilizer, erosion control, anionic (Nitrogen and Sulfur) stabilization, amelioration of heavy metal toxicity, and salinity. The compositions and methods also relate to the use of technology as a granulation and tablet binder, dust control agent, sedimentation control of liquid slurry suspensions, and flocculant. Lastly, compositions and methods have demonstrated benefits for animal and human health functioning as a gut prebiotic, binder for cholesterol and bile acids inhibiting reabsorption, accelerated wound healing, and reducing blood glucose levels. Lastly, the compositions and methods present an opportunity to develop a closed loop technology which utilizes co-products derived from the existing food industry, establishing new markets for waste products and opportunities for domestic food security.

During the exploration of various opportunities for increasing the viscosity of a liquid slurry, we have discovered that plant mucilage and extracellular polymeric substances (EPS) excreted from soil microorganisms shared mutual chemical and physical properties, predominantly viscosity, surface tension, and saccharide composition. Mucilage and EPS are responsible for trapping cations, in particular Calcium, which functions to increase the thickness of these biofilms functioning as a root protectant. Upon drying, these biofilms protect the root under drought due to their hydrophobic properties maintaining turgor pressure in the plant preventing hydraulic failure.

Additionally, plant biofilms also ameliorate heavy metal toxicity, salinity, and root oxidation. The biofilms also function as a substrate creating a microaerobic environment for bacterial enhancement and growth. Mucilage and EPS can also act as a nutrient source for the plant. Current rates of mucilage exudation on maize plants have been reported at 1.41 mg dry weight per day and root tip, with a maximum decomposition rate of 50% in 7 days (Nazari et al, 2022).

In some aspects, the invention describes a blend of a polysaccharide comprising a backbone of repeating D-galacturonic acid monomer units and a sugar. The polysaccharide and sugar blend is characterized by gelling of the polysaccharide upon solubilization of the blend in water and adjusting the temperature, pH, sugar content, or catalyst of the solution to effect gel formation. In some aspects the inventions describes a blend of consisting essentially of a polysaccharide and sugar blend. In some aspects, the inventions described a blend consisting of a polysaccharide and sugar blend. In this context, consisting essentially of is intended to mean that the blend comprises polysaccharide and sugar with other trace elements that comprise less than 20% of the composition as a whole and the other elements are not materially significant, are inactive or inert with respect to the function of the blend.

In some aspects, the invention describes a blend of a polysaccharide comprising a backbone of repeating D-galacturonic acid units; calcium; and sugar. The blend is characterized by structure-related gelling of the polysaccharide upon solubilization of the dry blend in water. In some aspects the inventions describes a blend of consisting essentially of a polysaccharide, calcium and sugar blend. In some aspects, the inventions described a blend consisting of a polysaccharide, calcium, and sugar blend. In this context, consisting essentially of is intended to mean that the blend comprises polysaccharide, calcium and sugar with other trace elements that comprise less than 20% of the composition as a whole and the other elements are not materially significant, are inactive or inert with respect to the function of the blend.

In some aspects, the invention encompasses a combination of a low methoxyl (LM)-pectin; milk powder or liquid; and sugar. In some aspects the inventions describes a blend of consisting essentially of (LM)-pectin, milk, and sugar blend. In some aspects, the inventions described a blend consisting of (LM)-pectin, milk, and sugar blend. In some aspects, the invention encompasses a low methoxyl (LM)-pectin in an amount, (w/w) of the dry blend of about 18%; milk powder in an amount, (w/w) of the dry blend of about 4%; and sugar in an amount, (w/w) of the dry blend of about 78%. In some aspects, the invention encompasses one pound of the dry blend composition of low methoxyl (LM)-pectin; milk powder or liquid; and sugar with between about two and about four gallons of water. In this context, consisting essentially of is intended to mean that the blend comprises low methoxyl (LM)-pectin; milk powder or liquid; and sugar with other trace elements that comprise less than 20% of the composition as a whole and the other elements are not materially significant, are inactive or inert with respect to the function of the blend.

In some aspects, the polysaccharide, calcium or sugar of any of these compositions are in a solid or liquid form.

In some aspects, the polysaccharide of any of these compositions are a homopolymer or heteropolymer.

In some aspects, the polysaccharide of any of these compositions are heteropolymeric polysaccharide comprises a backbone of repeating D-galacturonic acid monomer units while further comprising at least one of L-Rhamnose, KDO, DHA, D-Galactose, L-Fucose, D-Xylose, D-Glucuroic acid, L-Galactose, L-Arabinopyranose, L-Arabinofuranose, D-Apiose, or L-Aceric acid.

In some aspects, the polysaccharide of any of these compositions are amidated or non-amidated.

In some aspects, the sugar of any of these compositions is glucose. In some aspects, the sugar is a blend of glucose, galactose, mannose, gulose, talose, fructose or similar sugars. The term blend of glucose, galactose, mannose, gulose, talose, fructose or other sugars also covers mixtures of glucose and similar sugars, the sugars combined in any combination with respect to type of sugar and total amount of each sugar added to the whole mixture or blend or combined sugar component of the overall blend.

In some aspects any of these compositions are formulated as a kit comprising: a polysaccharide comprising a backbone of repeating D-galacturonic acid units, sugar, and optionally calcium as well as instructions for forming a blend of the polysaccharide, sugar, and optionally calcium and instructions for solubilizing the blend with water.

In some aspects any of these compositions are applicable as a synthetic root exudate. A solution formed from water and any of these compositions forms a synthetic root exudate. The synthetic root exudate being comparable to a plant mucilage and/or extracellular polymeric substances (EPS) in viscosity, surface tension and saccharide composition, and the synthetic root exudates acting a nutrient and water source for the plant.

In some aspects any of these compositions are applicable in a method of protecting plant roots. A solution formed from water and any of these compositions forms a synthetic root exudate. The method including steps of applying the solution to plant roots and drying the plant roots. The solution functions to maintain turgor pressure, provides nutrients and water to the plant roots for a period of time, thereby protecting the plant roots.

In some aspects any of these compositions are applicable in a method of stimulating growth of plant roots and increasing plant biomass. A solution formed from water and any of these compositions and the solution is applied to plant roots. The solution increases the thickness of a protectant surrounding the root, provides a substrate for creating a microaerobic environment for bacterial enhancement and growth, and provides a nutrient source for the plant, all of which thereby stimulate growth of the plant roots and enhancing plant biomass.

In some aspects any of these compositions are applicable in a method of delivering a product to a plant root system. A solution formed from water and any of these compositions also including a product. The solution is applied to plant roots, the solution increases the thickness of a protectant surrounding the root while additionally providing delivery means of the product in solution directly to the plant root. The product may be a nutrient, ameliorating agent, or plant protectant. In some aspects the product is not a plant growth promoting rhizobacteria.

In some aspects any of these compositions are applicable in a method of enhancing residency time of beneficial agents in a plant rhizosphere. A solution formed from water and any of these compositions also including a beneficial agent and the solution is applied to plant roots where the solution increases the thickness of a protectant surrounding the root and increases residence time of a beneficial agent in and around the plant root and the plant rhizosphere.

In some aspects any of these compositions are applicable in a method of reducing heavy metal toxicity and salinity of plant roots. A solution formed from water and any of these compositions and the solution is applied to plant roots, where the solution serves as an ameliorant of heavy metal toxicity and salinity.

In some aspects, any of these compositions are applicable in a method of controlling the sedimentation rate of a liquid slurry suspension for use as a root stimulant. A solution formed from water and any of these compositions and the solution and the solution is applied to plant roots, where a structure-related gelling of the polysaccharide in solution decreases the sedimentation rate of any non-soluble sediments or products within the solution when compared to a solution lacking the polysaccharide.

In some aspects any of these compositions are applicable in a method of coating a seed. A solution formed from water and any of these compositions and the solution is applied to a seed, and after drying the seed, a coated seed is formed. In some aspects, the invention also includes a coated seed, the coated seed including a seed and a coating surrounding the seed, the coating comprising any of the compositions.

In some aspects any of these compositions are applicable as a granular fertilizer including a polysaccharide comprising a backbone of repeating D-galacturonic acid monomer units, a sugar, and optionally calcium or calcium product blended uniformly together and provided in a granular form for application as a fertilizer.

### I. Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of ±1.5 wt % from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group, but only in trace amounts and only added components that can be considered inert or inactive.

Any component referred to in an amount defined by a %, wt %, wt %, or % by weight is intended to encompass a weight percent relative to the whole composition or blend being defined as 100%, 100 wt % or 100% by weight.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

### II. Polysaccharide

According to some aspects of the invention, any polysaccharide that has a characteristic of forming a structure-related gel in solution forms the foundation for the compositions and methods described herein. The terminology “structure-related gel formation” describes the formation of a viscous gel upon solubilization of the polysaccharide in solution.

### Pectins

In some aspect, the polysaccharide according to aspects of the invention is a pectin. Pectin is well known in the food industry to function as a thickening agent particularly for its gelling properties.

Generally, a pectin comprises a backbone of repeating D-galacturonic acid units or monomers. This backbone may comprise solely repeating D-galacturonic acid units. In some aspects, the backbone comprises D-galacturonic acid units repeating at regular intervals, for example every other unit. The pectin structure may be branched or linear. The pectin structure may comprise a homopolymer of D-galacturonic acid units. Alternatively, the pectin may comprise a heteropolymeric structure that, in addition to a backbone of repeating D-galacturonic acid units or monomers, additionally comprises branches comprising units other than D-galacturonic. That is, a pectin may comprise D-galacturonic acid, L-Rhamnose, KDO, DHA, D-Galactose, L-Fucose, D-Xylose, D-Glucuroic acid, L-Galactose, L-Arabinopyranose, L-Arabinofuranose, D-Apiose, or L-Aceric acid in any combination. For example, a pectin according to some aspects of the invention describe as an arabinogalactan I or II, a rhamnogalacturonan I or II.

Pectins belong to family of polysaccharides and can by either synthetic or plant derived. A pectin source may be an apple pomace, a black currant, a black mulberry pomace, cacao pod husks carrot, gold kiwifruit pomace, mango peel, okra, orange peel, peach, pistachio, plum, pomegranate, raspberry, soy, strawberry, sugar beet pulp, sunflower, yellow passion fruit peel.

Pectins share similar physical and chemical properties as plant mucilage and EPS and thus present a unique opportunity to act function as thickening agent, nutritional source for the plant, substate for soil microbiological enhancement, ameliorating agent, plant protectant, and other manufacturing opportunities.

Upon activation, Pectin forms what is referred to as an “egg-carton technology” which links the polysaccharide chains forming a gel. This “egg-carton technology” alters the structural and physical properties of water creating a substrate they can hold water suspendable substances in suspension.

Pectin's are classified based on their degree of esterification. High methoxyl (HM) pectin require heat and the pectin is activated by glucose and low methoxyl (LM)-pectin. HM pectin is commonly used in the food industry for jellies and jams, while LM pectin is utilized for similar low-sugar food products.

Low methoxyl pectin is differentiated from HM pectin in that it does not require heat or glucose to activate, LM pectin will activate in the presence of calcium, as calcium forms the cross-linking bridges binding the pectin polysaccharides and thus creating the “egg-carton technology”.

LM pectin also presents additional opportunities and advantages over its HM counterpart for agricultural purposes. It was discovered during initial testing, that LM pectin does not require heat to activate and can activate across a wide range of pH's.

Pectin based products present a unique opportunity, not only for plant and soil health benefits, but also as a novel granulation binder. The “egg-carton” technology of pectin and the hydrophobic properties once dried, present desired interest in the use of this technology as a binding agent, granulation stabilizer, and dust suppressant. LM pectin also present additionality as an organic flocculant or thickening agent based on the material loaded into the “egg-carton” technology and the desired syneresis.

The pectin based products available for use in aspects of this invention may be obtain from any source and processed or prepared by any means.

The pectin based products available for use in aspects of this invention may be amidated or non-amidated. In some aspects the amount of amidation of the pectin may include the rate or extend for polysaccharide gel formation in solution. Further the amount of amidation of the pectin may influence the amount of calcium required to form the “egg-carton” formation of the pectin.

The use of non-amidated LM pectin, derived from plant pomace (apple), is an approved organic amendment. Allowing for the patent to be suitable for organic and non-organic production systems if the ingredients are sourced appropriately and certified through the appropriate organic agencies.

The phrase pectin may also be known by the synonyms BETA-D-GALACTOPYRANURONIC ACID; 18968-14-4; beta-D-galacturonic acid; (2S,3R,4S,5R,6R)-3,4,5,6-tetrahydroxyoxane-2-carboxylic acid; 55NG309NDD; oligogalacturonide; UNII-55NG309NDD; SCHEMBL3407163; CHEBI:47954; Galactopyranuronic acid, beta-D-; ZINC4097542; DB03652; C08348; WURCS=2.0/1,1,0/[a2112A-1b_1-5]/1/; (2S,3R,4S,5R,6R)-3,4,5,6-Tetrahydroxytetrahydro-2H-pyran-2-carboxylic acid; and (2S,3R,4S,5R,6R)-3,4,5,6-Tetrahydroxytetrahydro-2H-pyran-2-carboxylicacid

### III. Structure-Related Gelling of the Polysaccharide

In some aspects, a “catalyst” may be necessary to commence or enhance formation of the structure-related gelling of the polysaccharide. Commencing or enhancing the formation of structure-related gelling of the polysaccharide may occur with a changes in temperature or pH of solution. For some LM-pectins, addition of calcium ion to the solution may commence or enhance the formation of structure-related gelling of the pectin. The source of calcium may be in the form of an ionic calcium powder, a liquid calcium concentrate, or a substance know to have high amounts of calcium such as milk in powdered or liquid form.

### IV Sugar

In some aspects, the solution of polysaccharide and “catalyst” may also be accompanied by a sugar. The sugar prevents pre-gelling and syneresis (clumping) during solubilization of the polysaccharide. The sugar by be in solid or liquid form. The sugar may be glucose. In some aspects, the sugar is a blend of different sugars, including for example a blend of glucose, galactose, mannose, gulose, talose, fructose or similar sugars. Similar sugars being any sugar or other structure that is useful in plant nutrition or enhancing solubilization of the polysaccharide.

### V Cation

In some aspects, the solution further comprises a source of cation. In some aspects the cation is Calcium. In some aspects, the source of Calcium is a milk product, though any souce of Calcium ion in any form , such as a salt are applicable to the solutions described herein. The cation may also be a Potassium or Magnesium or other cation. Further in some aspects, the cation may be any combination of Calcium, Potassium or Magnesium. In some aspects, the cation may be a combination of Calcium with any other cation.

### VI Additives

In some aspects, any other plant beneficial additive is added to a formulation comprising a pectin, a sugar and a cation. The additive may include for example, any ingredient typically found in a fertilizer or beneficial to bare plant roots or seeds for optimal maintenance and growth of the root or seed. The additive may include for example nitrogen, ammonia, urea, phosphates, potassium, manganese, boron, iron, chlorine, copper, molybdenum, minerals, herbicides, fungicides, pesticides, macro nutrients, micronutrients, vitamins, essential nutrients, vanadium, sulfur, magnesium, zinc, potash, EDTA, surfactants, saponifiers, or pH modifiers.

### EXAMPLES

For the purposes of promoting an understanding of the principles of the present disclosure, reference will now be made to preferred aspects and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

### Example 1: Formation of a Pectin, Calcium, Sugar Dry Blend

We successfully dry blended, LM pectin, glucose (sugar), and calcium (dry milk) prior to solubilization and activation which yielded a dry blended product with shelf-life storability, improved handling, and reduced shipping costs over the HM pectin and other glucose counterparts.

The dry sugar (glucose) component to this dry blend, was for the purpose of preventing pre-gelling of the LM pectin during solubilization. The glucose also functions to diversify the saccharoidal composition the final product.

Initial Dry blend formulation:
1. LM Pectin-18.1%
2. Dry Milk-3.8%
3. Sugar-78.1%

One pound of dry blend solubilized, yields 2-4 gallons of product, depending upon desired viscosity. 25 mg of Calcium is required to activate 1 g of low methoxyl pectin. The sugar target is 20% of the final liquid volume. The sugar prevents pre-gelling and syneresis (clumping) during solubilization, as such it is an important constituent of the final blend. Solubilization of the dry blend is enhanced with the use of a mixing cone and inductor system.

### Example 2: Applications of Dry Blend

The pectin, dry milk, and sugar dry blend of Example 1 is used as liquid bio stimulant fertilizer to be applied in furrow at planting. Prior to application, the user will solubilize the dry blend with water to the desired viscosity. Once solubilized the liquid can be applied through a liquid planter applicator. Once applied the solubilized dry blend will protect the emerging roots increasing water availability and nutrients to the newly germinated seed. Plant vigor will be enhanced, and root biomass will continue to increase.

The blend of Example is also used as a microbial substrate (biostimulant), a water storage enhancer; a soil aggregate stabilizer; a plant root stimulant; a plant root protectant; a salinity amelioration agent; a nutritional seed coating; a dust control agent; a fertilizer coating; a biofilm for pesticides (sticking agent); a fertilizer enhancer; a nitrogen stabilizer; a anti-leaching agent; a granulation binder; or a soil additive.

The blend of Example 1, once reconstituted in water as appropriate may be used as a spray on foliant.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A method of stimulating growth of plant roots and increasing plant biomass, the method comprising:
providing a polysaccharide having a backbone of repeating D-galacturonic acid units and sugar to form a blend;
solubilizing the blend in water to form a solution;
applying the solution to plant roots or a seed;
wherein the solution increases the thickness of a protectant surrounding the root, provides a substrate for creating a microaerobic environment for bacterial enhancement and growth, and provides a nutrient source for the plant, all of which thereby stimulate growth of the plant roots and enhancing plant biomass.

2. The method of claim 1, the blend further comprising calcium, milk powder, or milk liquid.

3. The method of claim 1, wherein the polysaccharide and sugar of the blend are in a solid or liquid form.

4. The method of claim 1, wherein the sugar of the blend is glucose or a blend of glucose with galactose, mannose, gulose, talose, fructose, or other sugars.

5. The method of claim 1, wherein the polysaccharide of the blend is a homopolymer or heteropolymer.

6. The method of claim 5, wherein the polysaccharide of the blend comprises a backbone of repeating D-galacturonic acid monomer units while further comprising at least one of L-Rhamnose, KDO, DHA, D-Galactose, L-Fucose, D-Xylose, D-Glucuroic acid, L-Galactose, L-Arabinopyranose, L-Arabinofuranose, D-Apiose, or L-Aceric acid.

7. The method of claim 1, further comprising a step of drying the plant roots after application of the solution, wherein the dried plant root surrounded by a dried solution maintains turgor pressure, provides nutrients and water to the plant roots, thereby protecting the plant roots.

8. The method of claim 1, further comprising adding to the blend a product, so that the solution applied to plant roots further provides a delivery means of the product directly to the plant root.

9. The method of claim 8, wherein the product is a nutrient, ameliorating agent, or plant protectant.

10. A blend comprising:
a polysaccharide having a backbone of repeating D-galacturonic acid monomer units; and
sugar,
wherein the polysaccharide and sugar blend is characterized by gelling of the polysaccharide upon solubilization of the blend in water and adjusting the temperature, pH, sugar content, or catalyst of the solution to effect gel formation.

11. The blend of claim 10 further comprising calcium, milk powder, or milk liquid.

12. The blend of claim 10, wherein the polysaccharide and sugar are in a solid or liquid form.

13. The blend of claim 10, wherein the polysaccharide is a homopolymer or heteropolymer.

14. The blend of claim 13, wherein the heteropolymeric polysaccharide comprises a backbone of repeating D-galacturonic acid monomer units while further comprising at least one of L-Rhamnose, KDO, DHA, D-Galactose, L-Fucose, D-Xylose, D-Glucuroic acid, L-Galactose, L-Arabinopyranose, L-Arabinofuranose, D-Apiose, or L-Aceric acid.

15. The blend of claim 10, wherein the polysaccharide is amidated or non-amidated.

16. The blend of claim 10, wherein the sugar comprises glucose.

17. The blend of claim 10, wherein the sugar is a blend of glucose, galactose, mannose, gulose, talose, fructose or similar sugars.

18. The blend of claim 10 further comprising instructions for forming a blend of the polysaccharide and sugar and instructions for solubilizing the blend with water so as to form a kit.

19. A synthetic root exudate comprising:
a polysaccharide having a backbone of repeating D-galacturonic acid units and sugar
to form a blend,
wherein, when the blend is solubilized in water to form a solution that is a synthetic root exudate, the synthetic root exudate being comparable to a plant mucilage and/or extracellular polymeric substances (EPS) in viscosity, surface tension and saccharide composition, and the synthetic root exudates acting a nutrient and water source for the plant.

20. The synthetic root exudate of claim 19, the blend further comprising calcium, milk powder, or milk liquid.
